(19) United States
(12) Patent Application Publication
(10) Pub. No.: US 2007/0012351 A1
(43) Pub. Date: Jan. 18, 2007

(54) FLUOROPOLYMER FILM HAVING GLASS MICROSPHERES

(75) Inventor: EDUARD M. HOREMANS, Brasschaat (BE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/424,666

(22) Filed: Jun. 16, 2006

(30) Foreign Application Priority Data
Jun. 17, 2005 (GB) 0512334.4

(51) Int. Cl. H02N 6/00

(52) U.S. Cl. 136/251

(57) ABSTRACT

The invention provides a film of fluoropolymer having glass microspheres dispersed in said fluoropolymer. The addition of glass microspheres to the fluoropolymer can overcome the behaviour of the fluoropolymer to stick to itself in a stack or when wound on itself in a roll. Hence an additional intermediate sheet or like material is not needed. Additionally, it has been found that the glass microspheres can be used during normal manufacturing of fluoropolymer films by melt-extrusion and moreover, films can be obtained in which other desired properties of the fluoropolymer are not adversely affected or any adverse effects are minimal.

This application claims priority to Great Britain Patent Application No. GBO5 12334.4, filed on Jun. 17, 2005, herein incorporated by reference in its entirety.

### FIELD OF THE INVENTION

The present invention relates to fluoropolymer films.

### BACKGROUND OF THE INVENTION

The beneficial properties of fluoropolymers are well known in the art and include for example, high temperature resistance, high chemical resistance including for example high resistance to solvents, fuels and corrosive chemicals, and non-flammability. Because of these beneficial properties, fluoropolymers find wide application particularly where materials are exposed to high temperature and/or chemicals.

Fluoropolymers and in particular films of fluoropolymers can and have been used as protective films in a variety of applications. For example, fluoropolymers have been suggested as protective films in solar cells. Solar cell units typically comprise a photovoltaic (PV) layer or element composed of a semiconductor material that is provided between a front electrode (at the front of the unit, i.e. on the side of the incident light) and a back electrode (at the back of the unit). The front electrode is transparent, enabling incident light to reach the semiconductor material, where the incident radiation is converted into electric energy. In this way light can be used to generate electric power, which offers an interesting alternative to, say, fossil fuels or nuclear power. However, in order to be economically attractive, the photovoltaic element needs to be provided in a suitable form and made by relatively low-cost processes. For example, U.S. Pat. No. 6,184,057 discloses photovoltaic elements made in the form of a foil. This process allows for economic production on a large scale (in a “roll-to-roll process”). Furthermore, photovoltaic elements on flexible substrates are more versatile and easier to handle.

In many applications where solar cells are exposed to extreme environments, including the exposure to damaging radiation particles, it is necessary to provide a protective cover such as a transparent cover glass or plastic based sheet or layer that will suitably shield the cells from these sources of potential damage. When the top layer is made of glass, it can be cleaned in principle, but this is a labour intensive process, not least because solar cell units are often to be found on roofs or in otherwise poorly accessible places. Plastics based top layers generally are more fragile than top layers based on a glass sheet. On the other hand, when a fluoropolymer material is used as the surface covering material, there are advantages such that the surface covering material comprising the fluoropolymer material excels in weatherability and water-repellency. Furthermore, lower reduction in the photoelectric conversion efficiency of the solar cell module occurs because the fluoropolymer material as the surface covering material is difficult to deteriorate or stain and therefore, the light transmittance thereof hardly decreases, and in addition, the fluoropolymer material excels in flexibility and is light, making it possible to obtain a solar cell module which is lightweight and excels in flexibility. WO 99/49483 in particular discloses a cost effective method for producing photovoltaic cells. In particular, this process involves a so-called roll to roll manufacturing process.

### SUMMARY OF THE INVENTION

However, one of the drawbacks that may be associated with fluoropolymers is that they may stick to themselves when they are provided in a stack or wound on themselves. Hence, fluoropolymers which display this so-called blocking behavior generally require the use of an intermediate sheet so as to avoid that the fluoropolymer films come into contact with themselves. The presence of such an intermediate sheet provides additional costs and complicates the manufacturing process of articles made from the fluoropolymer such as for example the manufacturing of solar cells in the roll to roll manufacturing disclosed in WO 99/49483.

It would thus be desirable to find a way to avoid the so-called blocking of fluoropolymer films without the need for an intermediate sheet. Desirably, such solution will not affect or only affect in a minimal amount other beneficial and desired properties such as for example the transparency of the film if the fluoropolymer film is to be used as a protective film in a solar cell. The solution should also be compatible with the common methods of manufacturing fluoropolymer films such as extrusion of the fluoropolymer. Desirably, the solution is also cost effective and economically attractive.

In accordance with one aspect of the present invention, there is provided a film of fluoropolymer having glass microspheres dispersed in said fluoropolymer. It has been found that the addition of glass microspheres to the fluoropolymer may overcome the behaviour of the fluoropolymer to stick to itself in a stack or when wound on itself in a roll. Hence an additional intermediate sheet or like material is typically not needed. Additionally, it has been found that the glass microspheres can be used during normal manufacturing of fluoropolymer films by melt-extrusion and moreover, films can be obtained in which other desired properties of the fluoropolymer are not adversely affected or any adverse effects are minimal.

In a further aspect, the present invention provides a method of making a fluoropolymer film by extruding a fluoropolymer having dispersed therein glass microspheres into a film.

In a still further aspect, there is provided a stack of film sheets comprising a stack of a plurality of the films of fluoropolymer on top of each other such that the films are in direct contact with each other.

In a still further aspect, the present invention provides a roll of the fluoropolymer film wound on itself.

In yet another aspect, there is provided a photovoltaic assembly comprising a photovoltaic element and the film of fluoropolymer arranged thereon as a protective layer.

### DETAILED DESCRIPTION OF THE INVENTION

The film of fluoropolymer is typically composed of one or more fluoropolymers and is in particular a film that without the presence of the glass microspheres sticks on itself such that when a plurality of sheets are stacked on top of each other with the films being in direct contact with each other, resistance is observed when trying to withdraw one film from the stack or in a severe case, it may not be possible or very difficult to withdraw individual films from the stack. This behaviour of the fluoropolymer film may be particularly noticeable when the film is wound on itself. In such case, it may be difficult or even be impossible to unwind the roll. This behaviour will hereinafter be referred to as ‘blocking’ and is the result of a high coefficient of friction between the surfaces of two fluoropolymer films.

Examples of fluoropolymers that display the aforementioned blocking behaviour include polymers derived from tetrafluoroethylene (TFE), hexafluoropropylene (HFP) and vinylidene fluoride (VDF) optionally comprising one or more comonomers such as perfluorinated vinyl ethers and in particular perfluoroalkyl vinyl ethers. The fluoropolymer may be amorphous as well as semicrystalline. When the fluoropolymer is semicrystalline, it will typically have a melting point between 120 and 230° C.

The glass microspheres used in the fluoropolymer film may be any type of hollow or solid spheres. Generally however, hollow glass spheres are used. Useful microspheres are hollow, generally round but need not be perfectly spherical; they may be cratered or ellipsoidal, for example. Such irregular, though generally round or spherical, hollow products are regarded as “microspheres” herein.

The microspheres for use in the fluoropolymer film are generally from about 5 to 100 micrometers in volume average diameter. In a particular embodiment, the microspheres have a volume average diameter between 10 and 50 micrometers. A practical and typical volume average diameter may be from 15 to 40 micrometers. Microspheres comprising different sizes or a range of sizes may be used.

It will generally be preferred that the microspheres have a collapse strength in excess of the anticipated pressures that may arise in the manufacturing of the fluoropolymer film. Generally the microsphere component should have a burst strength in excess of 4000 psi (27.6 MPa), preferably in excess of 5000 psi (34.5 MPa) as measured by ASTM D3102-78 with 10% collapse and percent of total volume instead of void volume as stated in the test. In a particular embodiment, the glass microspheres have a burst strength of at least 15 000 psi or even higher such as for example at least 18 000 psi.

The density of hollow glass microspheres for use with this invention may vary from about 0. 1 to 0.9 g/cm³, and is typically in the range of 0.2 to 0.7 g/cm³. Density is determined (according to ASTM D-2840-69) by weighing a sample of microspheres and determining the volume of the sample with an air comparison pycnometer (such as a AccuPyc 1330 Pycnometer or a Beckman Model 930). Higher densities can produce higher strengths, and densities of 0.5 or 0.6 g/cm³ or more can be used with this invention.

Glass microspheres have been known for many years, as is shown by European Patent 0 091,555, and U.S. Pat. Nos. 2,978,340, 3,030,215, 3,129,086 3,230,064, and U.S. Pat. No. 2,978,340, all of which teach a process of manufacture involving simultaneous fusion of the glass-forming components and expansion of the fused mass. U.S. Pat. Nos. 3,365,315 (Beck), U.S. Pat. No. 4,279,632 (Howell), U.S. Pat. No. 4,391,646 (Howell) and U.S. Pat. No. 4,767,726 (Marshall) teach an alternate process involving heating a glass composition containing an inorganic gas forming agent, and heating the glass to a temperature sufficient to liberate the gas and at which the glass has viscosity of less than about 10⁴ poise.

Size of hollow glass microspheres can be controlled by the amount of sulfur-oxygen compounds in the particles, the length of time that the particles are heated, and by other means known in the art. The microspheres may be prepared on apparatus well known in the microspheres forming art, e.g., apparatus similar to that described in U.S. Pat. Nos. 3,230,064 or 3,129,086.

One method of preparing glass microspheres is taught in U.S. Pat. No. 3,030,215, which describes the inclusion of a blowing agent in an unfused raw batch of glass-forming oxides. Subsequent heating of the mixture simultaneously fuses the oxides to form glass and triggers the blowing agent to cause expansion. U.S. Pat. No. 3,365,315 describes an improved method of forming glass microspheres in which pre-formed amorphous glass particles are subsequently reheated and converted into glass microspheres. U.S. Pat. No. 4,391,646 discloses that incorporating 1-30 weight percent of B₂O₃, or boron trioxide, in glasses used to form microspheres, as in U.S. Pat. No. 3,365,315, improves strength, fluid properties, and moisture stability. A small amount of sodium borate remains on the surface of these microspheres, causing no problem in most applications. Removal of the sodium borate by washing is possible, but at a significant added expense; even where washing is carried out, however, additional sodium borate leaches out over a period of time.

Hollow glass microspheres are preferably prepared as described in U.S. Pat. No. 4,767,726. These microspheres are made from a borosilicate glass and have a chemical composition consisting essentially of SiO₂, CaO, Na₂O, B₂O₃, and SO₃ blowing agent. A characterizing feature of hollow microspheres resides in the alkaline metal earth oxide:alkali metal oxide (RO:R₂O) ratio, which substantially exceeds 1:1 and lies above the ratio present in any previously utilized simple borosilicate glass compositions. As the RO:R₂O ratio increases above 1:1, simple borosilicate compositions become increasingly unstable, devitrifying during traditional working and cooling cycles, so that “glass” compositions are not possible unless stabilizing agents such as Al₂O₃ are included in the composition. Such unstable compositions have been found to be highly desirable for making glass microspheres, rapid cooling of the molten gases by water quenching, to form frit, preventing devitrification. During subsequent bubble forming, as taught in aforementioned U.S. Pat. Nos. 3,365,315 and 4,391,646, the microspheres cool so rapidly that devitrification is prevented, despite the fact that the RO:R₂O ratio increases even further because of loss of the relatively more volatile alkali metal oxide compound during forming.

Suitable glass microspheres that may be used in connection with the present invention include those commercially available from 3M Company such as Scotchlite™ S60HS. The amount of glass microspheres used in the fluoropolymer may vary widely and can be easily determined by one skilled in the art and optimized according to desired properties. Typically however, an amount of at least 0.05% by weight based on the weight of fluoropolymer is used. In a particular embodiment, an amount of at least 0.1% by weight is used. The maximum amount of glass microspheres is typically determined by economical factors and/or desired properties of the fluoropolymer film. In a typical embodiment, the amount of glass microspheres is between 0.1 and 5% by weight, for example between 0.1 and 2% by weight. A practical range is between 0.2 and 1.5% by weight. Particular properties of the film that may determine the appropriate maximum amount of glass microspheres is the required transparency of the film. Depending on the desired transparency and nature of the fluoropolymer in the film, the amount of glass microspheres should not be more than 3% by weight for example not more than 2% by weight.

The fluoropolymer film may have a thickness of 50 to 500 μm with a convenient range being between 80 and 250 μm. When transparency of the film is an important consideration, the film thickness generally should not exceed 180 μm. The fluoropolymer films according to the invention can generally be readily stacked on top of each other without the need for intermediate release sheets or like materials. Similarly, the fluoropolymer films typically can be wound on themselves without the need for an intermediate release sheet. Such rolls can typically be easily rewound and are therefore particularly suitable for use in a roll-to-roll manufacturing process of solar cells as disclosed in WO 99/49483.

To produce the fluoropolymer film, a mixture of the fluoropolymer and appropriate amount of glass microspheres may be extruded using extrusion conditions typically used for the melt extrusion of the particular fluoropolymer film. A mixture of the fluoropolymer and glass microspheres may be produced by dry blending the microspheres with the fluoropolymer or the glass microspheres may be directly added to the molten fluoropolymer in the extruder. Generally, the fluoropolymer will be extruded at a temperature of 200 to 295° C. and a pressure of 60 to 75 bar. In the melt extrusion of the fluoropolymer to form a film, the film will typically be cooled on one or more rolls. By varying the degree of roughness of these cooling rolls, the transparency of the film can be influenced. Further, the transparency will depend on the nature of the fluoropolymer used as well as the speed of cooling. The transparency will further depend on additives including the microspheres that may be present in the film and the thickness of the extruded film. These factors may be readily and conveniently adjusted to obtain a desired transparency of the film if such is desired for the application.

According to a particular embodiment in connection with the invention, the fluoropolymer films produced will have a total light transmittance of at least 80%, for example at least 90% in the spectral range of 250 nm to 1100 nm and measured by ASTM E903 and E891. Films having this level of transparency are particularly suitable for use as protective films in solar cells.

In a particular embodiment of the present invention, the fluoropolymer film is used as a protective film in a photovoltaic assembly comprising a photovoltaic element. The photovoltaic element of the assembly generally comprises a photovoltaic layer composed of a semiconductor material that is provided between a front electrode (at the front of the unit, i.e. on the side of the incident light) and a back electrode (at the back of the unit). The front electrode is transparent, enabling incident light to reach the semiconductor material, where the incident radiation is converted into electric energy. In this way the photovoltaic element can be used to generate electric power from light. The fluoropolymer film according to the present invention can be arranged on the photovoltaic element as a protective layer.

According to a particular embodiment, the fluoropolymer film is arranged on the front side of the photovoltaic element. Typically, the fluoropolymer film will be bonded to the front side of the photovoltaic element. Any suitable means for bonding a fluoropolymer film to a substrate may be used. For example, the fluoropolymer film may be bonded to the photovoltaic element by the method disclosed in WO 86/03885 which involves a plasma etching of the fluoropolymer film.

The invention is further illustrated with reference to the following examples without the intention to limit the invention thereto.

### EXAMPLES

In the following examples and comparative examples, films have been made of fluoropolymers comprising glass microspheres. The films were evaluated for their light transmittance and their ability for easy unwind or release after they were wound on themselves or stacked on top of each other.

All percentages are by weight.

Abbreviations

Scotchlite® S60HS : high strength glass microspheres, with a density of 0.6 kg/l and a strength of 18000 psi, commercially available from 3M

FC-1: fluoroplastic comprising 60% TFE, 22% VDF and 18% HFP

FC-2: fluoroplastic comprising 47,6% TFE, 23,1% VDF, 25,3% HFP and 4% PPVE-1 PPVE-1:CF₃CF₂CF₂OCF═CF₂

Preparation of Fluoropolymer Films Comprising Glass Microspheres

Fluoropolymer films were prepared by first dry tumbling fluoropolymer agglomerate with hollow glass microspheres Scotchlite® S60HS, in amounts as given in the examples (as % by weight based on the weight of the fluoropolymer), using a tumble mixer during 20 min. The blend was then extruded on a 30 mm IDE extruder, equipped with a Collin chill roll/winding station, using a temperature between 200° C. and 295° C. and a pressure between 60 and 75 bar, to form a film having a thickness as indicated in the examples. After the films were conditioned at room temperature for 48 hours, they were stacked on top of each other or wound on themselves and the ability for release or unwind was evaluated. The films were further tested for their light transmittance at different wavelengths.

### Examples 1 to 5 and Reference 1 (Ref 1)

In examples 1 to 5, fluoropolymer films, comprising different levels of glass microspheres Scotchlite® S60HS, were prepared by extrusion as given in the general procedure. The films were made at 100 μm thickness. The films were wound on themselves and tested for easy unwinding after 48 hours. All films comprising glass microspheres could be easily unwound without problems. A reference (Ref 1), made fluoropolymer without the addition of glass microspheres, could not be unwound after 48 hours without difficulty. The composition of the examples and reference is given in table 1.

TABLE 1
Composition of fluoropolymer films comprising glass microspheres

| Ex No | Fluoropolymer | % Scotchlite ® S60HS |
|---|---|---|
| 1 | FC-1 | 0.1 |
| 2 | FC-1 | 0.5 |
| 3 | FC-1 | 1 |
| 4 | FC-1 | 2 |
| 5 | FC-2 | 0.5 |
| Ref 1 | FC-1 | / |

### Examples 6 and 7 and Reference 2 (Ref 2)

In Example 6, a fluoropolymer film of FC-1, comprising 0.1% Scotchlite® S60HS, was extruded at a thickness of 150 μm. In example 7, a fluoropolymer film of FC-1, comprising 1% Scotchlite® S60HS was extruded at a thickness of 175 m. The light transmittance was evaluated over a wide spectrum, according to ASTM E903 and E891 and using a UV/VIS Spektrometer Lambda 35, equipped with a reflectance Spectroscopy accessory RSA-PE-20, available from Perkin Elmer. The results of light transmittance were compared to results obtained with a reference film, made of pure FC-1 and extruded at a thickness of 150 μm. The results are given in table 2.

TABLE 2
light transmittance of fluoropolymer films comprising glass microspheres

| | Light transmittance | | |
|---|---|---|---|
| Wavelength (nm) | Ex 6 | Ex 7 | Ref |
| 250 | 92 | 88 | 93 |
| 300 | 93 | 89 | 95 |
| 350 | 102 | 87 | 97 |
| 400 | 96 | 91 | 95 |
| 450 | 95 | 91 | 96 |
| 500 | 97 | 92 | 97 |
| 550 | 97 | 92 | 97 |
| 600 | 97 | 92 | 97 |
| 650 | 97 | 93 | 97 |
| 700 | 97 | 92 | 98 |
| 750 | 97 | 93 | 98 |
| 800 | 97 | 93 | 98 |
| 850 | 97 | 93 | 98 |
| 900 | 97 | 93 | 98 |
| 950 | 97 | 93 | 98 |
| 1000 | 97 | 93 | 98 |
| 1050 | 97 | 92 | 97 |
| 1100 | 95 | 93 | 98 |

What is claimed is:

1. A film comprising a fluoropolymer having glass microspheres dispersed in said fluoropolymer.

2. A film according to claim 1 having a thickness of 50 to 180 μm.

3. A film according to claim 1 wherein said glass microspheres are hollow.

4. A film according to claim 1 wherein said glass microspheres are solid.

5. A film according to claim 1 wherein said glass microspheres are dispersed in said fluoropolymer in an amount of 0.05 to 2 percent by weight based on the weight of said fluoropolymer.

6. A film according to claim 1 wherein the glass microspheres have a volume average diameter between 10 to 50 μm.

7. A film according to claim 3 wherein said glass microspheres have a strength of at least 5000 psi.

8. A film according to claim 1 wherein said fluoropolymer is semi-crystalline fluoropolymer having a melting point between 120° C. and 230° C.

9. A film according to claim 1 wherein the fluoropolymer is a copolymer derived from tetrafluoroethylene, hexafluoropropylene and vinylidene fluoride.

10. A film according to claim 1 wherein the film has a total light transmittance of at least 80% in the spectrum between 250 nm and 1100 nm.

11. Stack of film sheets comprising a stack of a plurality of films as defined in claim 1 stacked on top of each other such that the films are in direct contact with each other.

12. Roll of film comprising a film as defined in claim 1 wound on itself.

13. Photovoltaic assembly comprising a photovoltaic element and film as defined in claim 1 arranged thereon as a protective layer.

14. Method of making a film as defined in claim 1 comprising extruding a fluoropolymer wherein the fluoropolymer has glass microspheres dispersed therein.
